(19) United States
(12) Patent Application Publication
(10) Pub. No.: US 2026/0171301 A1
(43) Pub. Date: Jun. 18, 2026

(54) METHOD FOR MAKING AN INDUCTOR

(71) Applicant: Vishay Dale Electronics, LLC, Columbus, NE (US)

(72) Inventors: Benjamin HANSON, Lennox, SD (US); Tyler WITZEL, Yankton, SD (US)

(73) Assignee: Vishay Dale Electronics, LLC, Columbus, NE (US)

(21) Appl. No.: 19/535,455

(22) Filed: Feb. 10, 2026

Related U.S. Application Data
(62) Division of application No. 17/187,161, filed on Feb. 26, 2021, now Pat. No. 12,567,533.
(60) Provisional application No. 62/984,584, filed on Mar. 3, 2020.

(51) Int. Cl. H01F 27/29; H01F 27/255

(52) U.S. Cl. CPC H01F 27/29; H01F 27/255

(57) ABSTRACT

A method for making an inductor including providing a formed conductive coil having a curve-shaped medial portion and first and second terminal leads, and molding a magnetic material around at least the medial portion of the formed conductive coil to form an inductor body. At least a portion of each of the first and second terminal leads of the formed conductive coil is exposed outside of the inductor body.

### CROSS REFERENCE TO RELATED APPLICATION

This application is a division of U.S. patent application Ser. No. 17/187,161, filed on Feb. 26, 2021, which claims the benefit of U.S. Provisional Application Ser. No. 62/984,584, filed on Mar. 3, 2020, which are incorporated by reference as if fully set forth herein.

### FIELD OF INVENTION

This application relates to the field of electronic components, and more specifically, inductors and methods and assemblies for making inductors.

### BACKGROUND

Inductors are, generally, passive two-terminal electrical components which resist changes in electric current passing through them. An inductor includes a conductor, such as a wire, wound into a coil. When a current flows through the coil, energy is stored temporarily in a magnetic field in the coil. When the current flowing through an inductor changes, the time-varying magnetic field induces a voltage in the conductor, according to Faraday's law of electromagnetic induction.

Some known inductors are generally formed having a thin conductive wire sandwiched between or wound about multi-piece molded magnetic core materials having a C-shape, E-shape, a toroidal shape, or other shape, which can be attached by an adhesive. Air spaces are prevalent in inductor core designs where the core is made from two separate halves of magnetic core materials. Such air spaces can negatively affect operation and performance of the inductor.

Other known inductors are formed by pressing a powdered magnetic material around a conductive body. With such known inductors, the conductive coil has some ability to move within the die, particularly during pressing. As a result, the conductive coil can move within the core which can negatively affect the operation and performance of the inductor.

Some known inductors generally require that the conductive coil be welded to a lead frame to hold the parts together during formation. After pressing the magnetic material around the conductive coil, the leads must then be formed, such as by cutting the lead frame and bending the leads, to form the leads. Post-processing steps, such as cutting and bending, can lead to cracks or other imperfections in the integrity of the conductive wire or molded magnetic material and result in a significant amount of waste material and extra labor.

An issue within the relevant industry as it concerns inductors relates to inspection of lead areas suitable for solder connections. For example, these inspections can be performed by x-ray or by automated optical inspection (AOI). Automated optical inspection (AOI) systems are used to inspect, for example, semiconductor devices and printed circuit boards (PCBs), for defects. It is desirable to make an inductor having a lead that can allow for improved AOI, which is less costly than x-ray inspections.

A need exists for a simple and cost efficient way to produce an inductor utilizing the smallest footprint possible while maximizing the useable core area with minimal waste material.

### SUMMARY

An inductor and method for making the same is disclosed herein.

In accordance with an aspect, the subject matter disclosed herein relates to an inductor including a preformed conductive coil comprising a medial portion between first and second terminal leads, and an inductor body comprising a magnetic material surrounding at least the medial portion of the preformed conductive coil. At least a portion of each of the first and second terminal leads of the preformed conductive coil is exposed outside of the inductor body.

In accordance with another aspect, the magnetic material can be magnetic particles that are molded around the medial portion of the conductive coil and portions of the first and second terminal leads of the conductive coil. The magnetic particles can be a powdered or granular magnetic material, or more particularly, powdered iron particles.

In accordance with another aspect, a conductive coil may be formed by bending a conductive material into a selected shape. The conductive coil can be circular, semi-circular, oblong, or omega-shaped.

In accordance with another aspect, the inductor body can be package-shaped having a bottom side (i.e., lead side), a top side, a right side, a left side, a front side, and a back side, and the portion of each of the first and second terminal leads exposed outside of the inductor body can be positioned along the bottom side or lead side of the inductor body. Each of the first and second terminal leads can further include a bottom portion that has an exposed portion positioned along the bottom side of the inductor body, and a side portion that terminates along a respective one of the right side and left side of the inductor body. Each of the right side and left side of the inductor body can include a cutout portion where the side portion of the respective one of the first and second terminal leads is positioned. The side portion of each of the first and second terminal leads can be preformed to be substantially perpendicular to the bottom portion.

In accordance with another aspect, the subject matter disclosed herein relates to a method for making an inductor which includes providing a conductor having a substantially curve-shaped medial portion and first and second terminal leads and molding a magnetic material around at least the medial portion of the formed conductive coil to form an inductor body, wherein at least a portion of the first and second terminal leads of the formed conductive coil can be exposed outside of the inductor body. The formed inductor body can be package-shaped having a bottom side, a top side, a right side, a left side, a front side, and a back side, and the first and second terminal leads can be exposed along the bottom side and a respective one of the right side and the left side of the inductor body. Molding the magnetic material can further include positioning the formed conductive coil in a mold assembly, introducing magnetic particles into the mold assembly, and pressing the magnetic particles around the conductive coil. Positioning the formed conductive coil can further include seating the first and second terminal leads of the formed conductive coil on first and second shelves formed within a wall of the mold assembly, wherein the first and second shelves have a shape that is complementary to the first and second terminal leads such that the first and second terminal leads function as a part of the wall of the mold assembly during molding. The first and second shelves can each further include a narrowing wall which forms a complementary cutout in each of the right side and the left side of the inductor body, and a portion of each of the first and second terminal leads can be positioned in a respective cutout.

In accordance with another aspect, the subject matter disclosed herein relates to an assembly for forming an inductor. The assembly includes a preformed conductive coil comprising a medial portion between first and second terminal leads, a mold section having a seating channel defined there through and a wall surrounding the seating channel, the wall comprising first and second shelves configured to receive the first and second terminal leads of the preformed conductive coil, and at least one punch configured to press magnetic particles around the conductive coil when the conductive coil is positioned within the mold. The first and second shelves have a shape that is complementary to the first and second terminal leads such that the first and second terminal leads contact the wall of the mold when the magnetic particles are pressed around the conductive coil.

### BRIEF DESCRIPTION OF THE DRAWINGS

FIG. 1A is an isometric view of the lead-side of an exemplary embodiment of an inductor according to the present invention.

FIG. 1B is a partial transparent view of the inductor body of FIG. 1A showing the conductive coil.

FIG. 1C is an isometric view of the front-right side of the inductor of FIG. 1A.

FIG. 1D is a partial transparent view of the inductor body of FIG. 1C showing the conductive coil.

FIG. 1E is a plan view of the front side of the inductor of FIG. 1A.

FIG. 1F is a partial transparent view of the inductor body of FIG. 1E showing the conductive coil.

FIG. 1G is a plan view of the right side of the inductor of FIG. 1A. The left side of the inductor of FIG. 1A is preferably a mirror image of the right side depicted in FIG. 1G.

FIG. 1H is a partial transparency view of the inductor body of FIG. 1G showing the conductive coil.

FIG. 2A is an isometric view of the front side of an exemplary embodiment of the conductive coil of FIGS. 1A-1B of the present invention.

FIG. 2B is an isometric view of the top side of the conductive coil of FIG. 2A.

FIG. 2C is an isometric view of the bottom side of the conductive coil of FIG. 2A.

FIG. 2D is a plan view of a right side of the conductive coil of FIG. 2A. The left side of the conductive coil of FIG. 2A is preferably a mirror image of the right side depicted in FIG. 2D.

FIG. 3 is a flow diagram of an exemplary method for forming an inductor with a preformed termination according to the present invention.

FIG. 4A is a plan view of an exemplary mold section for forming an inductor with a preformed termination according to the present invention.

FIGS. 4B and 4C are perspective views of the mold section of FIG. 4A.

FIGS. 5A and 5B are perspective views of the mold section of FIG. 4A with a conductive coil seated in a seating channel.

FIG. 6A is a perspective view of the mold assembly for forming an inductor with a preformed termination according to the present invention.

FIG. 6B is a cross sectional view of the mold assembly of FIG. 6A showing a conductive coil seated within the mold assembly.

FIG. 6C is a cross sectional view of the mold assembly of FIG. 6A showing a formed inductor with a preformed termination according to the present invention within the mold assembly.

FIG. 7 is a perspective view of the mold section of FIG. 4A showing a formed inductor according to the present invention seated within the seating channel.

FIG. 8A is a partial transparent view of another exemplary embodiment of an inductor according to the present invention showing the conductive coil.

FIG. 8B is an isometric view of the is an isometric view of the conductive coil of FIG. 8A.

FIG. 8C is a plan view of a right side of the conductive coil of FIG. 8B. The left side of the conductive coil of FIG. 8B is preferably a mirror image of the right side depicted in FIG. 8C.

FIG. 9A is a partial transparent view of another exemplary embodiment of an inductor according to the present invention showing the conductive coil.

FIG. 9B is a plan view of the conductive coil of FIG. 9B.

### DETAILED DESCRIPTION

An inductor with a preformed termination and method for making the same using a mold assembly are described herein.

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

The description provided herein is to enable those skilled in the art to make and use the described embodiments set forth. Various modifications, equivalents, variations, combinations, and alternatives, however, will remain readily apparent to those skilled in the art. Any and all such modifications, variations, equivalents, combinations, and alternatives are intended to fall within the spirit and scope of the present invention defined by claims.

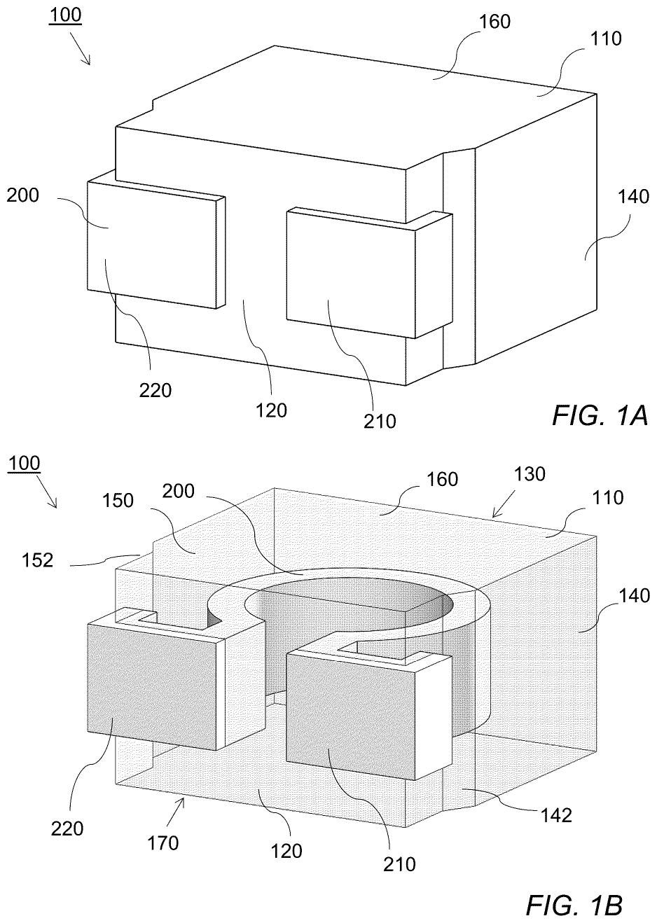

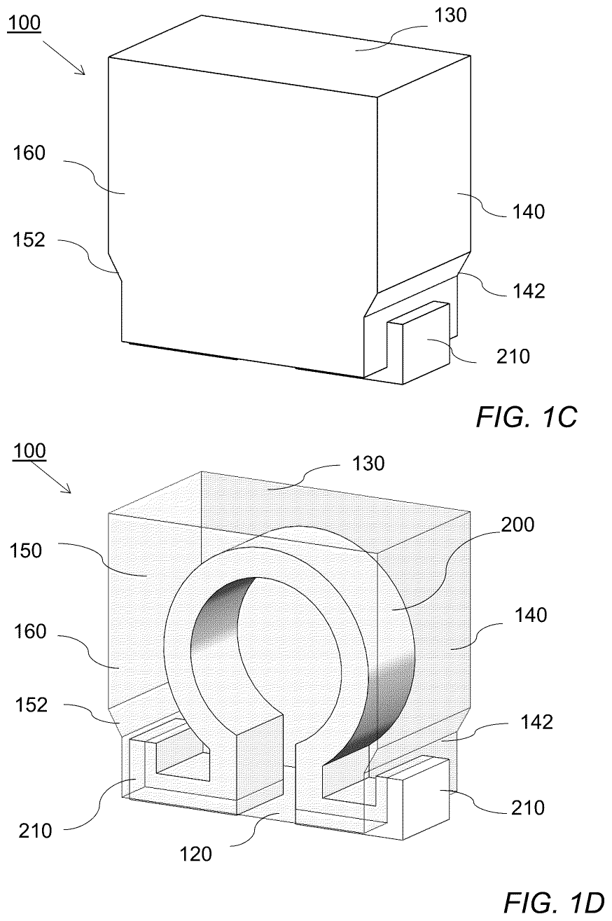

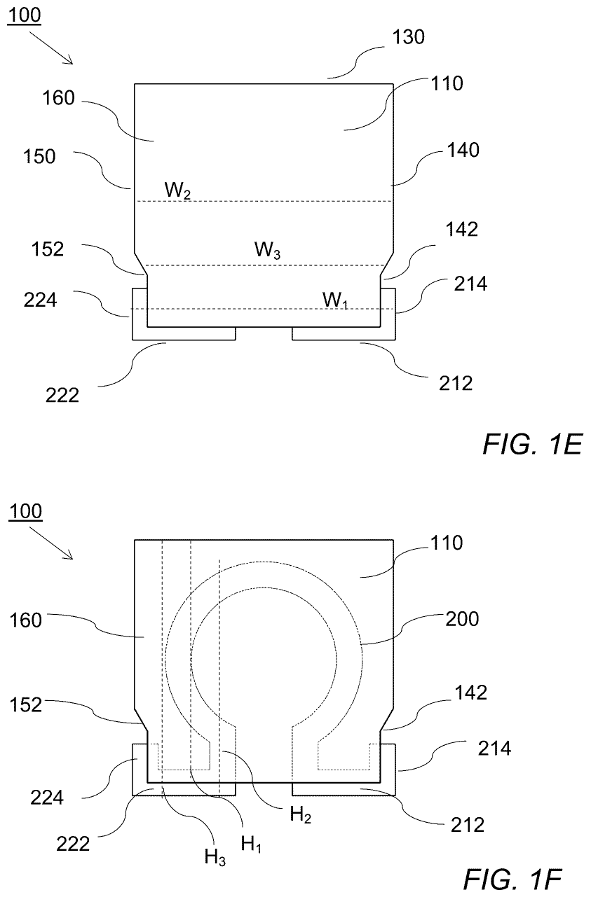

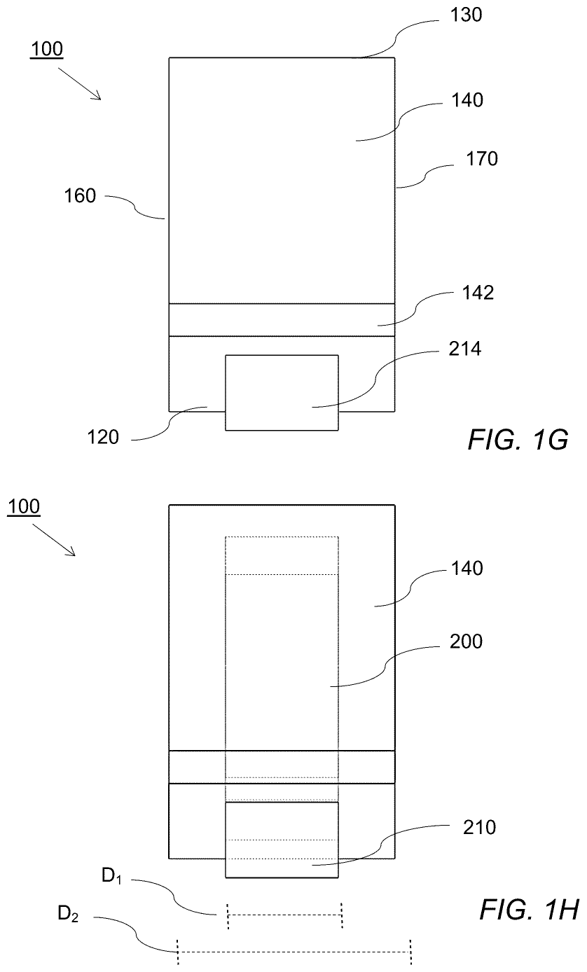

FIGS. 1A-1H show an inductor 100 according to an exemplary embodiment described herein. The inductor 100 preferably includes an inductor body 110 partially surrounding a preformed conductive coil 200. The inductor body 110 is preferably formed of a magnetic material that is molded about the conductive coil 200. In an embodiment, the inductor body 110 may be formed of a ferrous material. In an embodiment, the inductor body 110 may comprise, for example, iron, metal alloys, ferrite, combinations of the foregoing, or other materials known in the art of inductors and used to form such bodies. In an embodiment, the inductor body 110 may be formed from magnetic particles such as powdered or granular magnetic particles. In an embodiment, the magnetic particles can be powdered iron particles. In a non-limiting example, a magnetic material may be used for the inductor body comprised of a powdered iron particles, a filler, a resin, and a lubricant, such as described in U.S. Pat. No. 6,198,375 (“Inductor Coil Structure”) and U.S. Pat. No. 6,204,744 (“High Current, Low Profile Inductor”), both of which are incorporated by reference as if fully set forth herein.

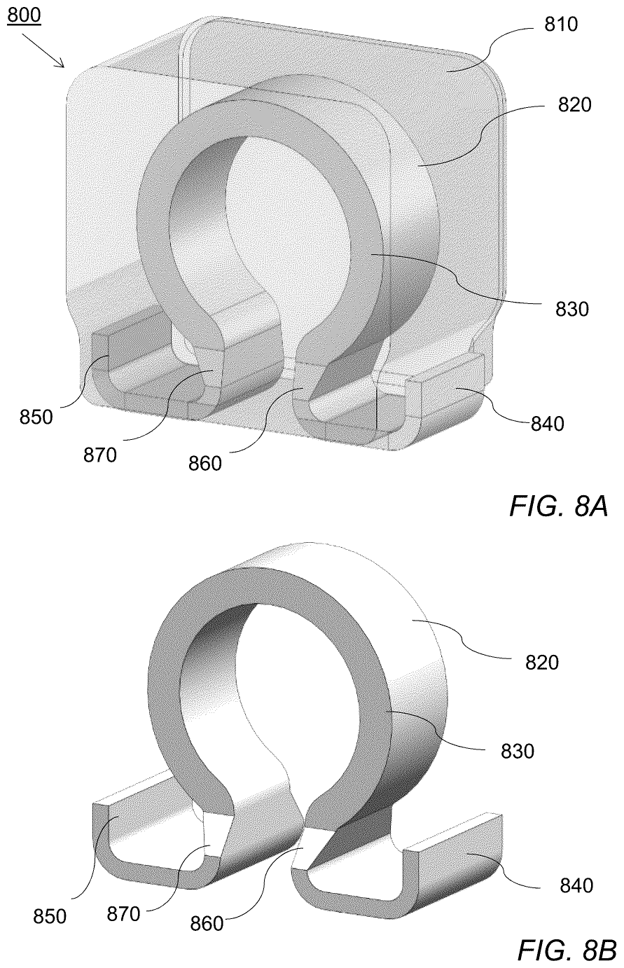

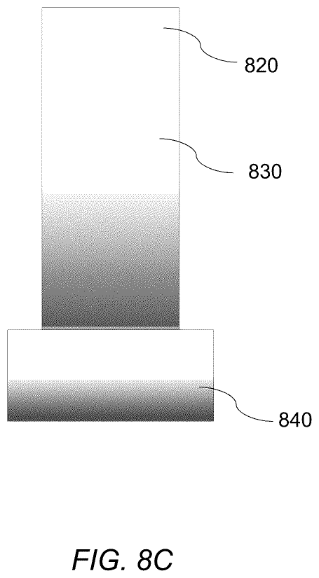

As shown in FIGS. 1A-1H, in an exemplary embodiment, the inductor body 110 is preferably package-shaped having a bottom side or lead side 120, a top side 130, a right side 140, a left side 150, a front side 160, and a back side 170. Non-limiting examples of a package-shape include a box-shape, a cuboid shape, a rectangular prism, any of the foregoing including rounded corners (see FIG. 8A), one or more irregular surface, etc. One of ordinary skill in the art will recognize that other inductors shapes can be employed without departing from the spirit of the invention. For example, an inductor 100 with preformed terminations formed according to the present disclosure, can have non-matching mold sections that are formed together in a mold assembly. The inductor body 110 is preferably formed about the conductive coil 200 such that right and left leads 210, 220 of the conductive coil 200 are exposed outside of the inductor body 110 along the lead side 120 of the inductor body 110.

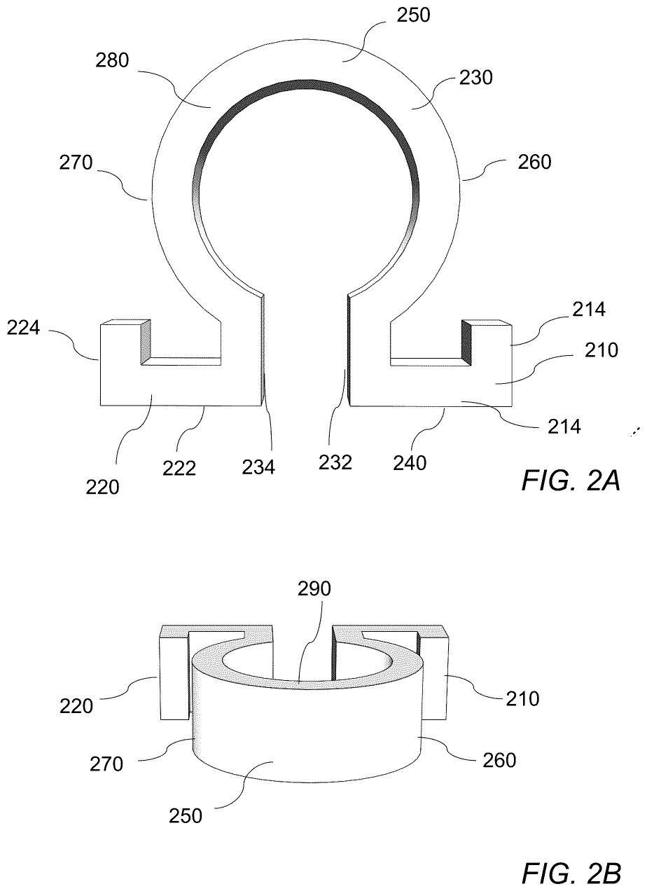

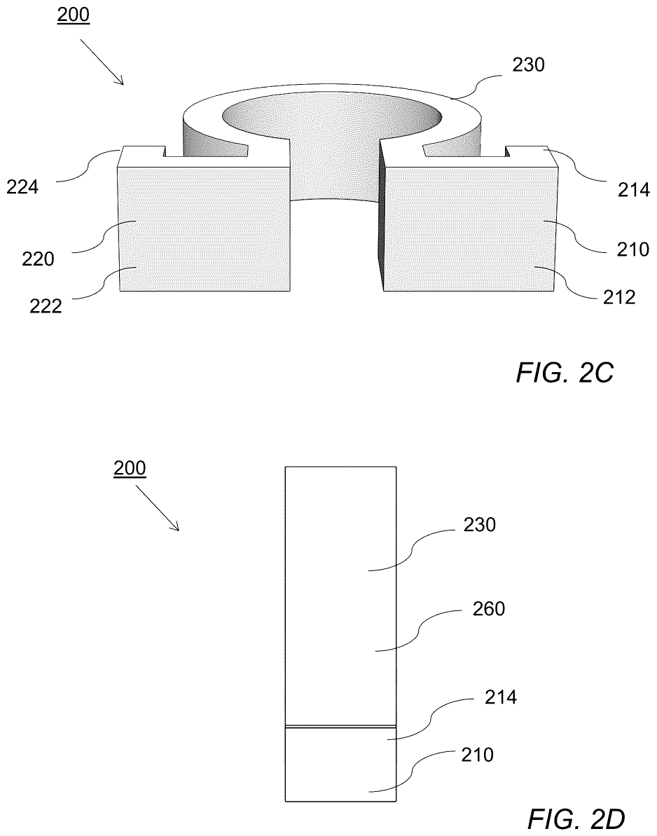

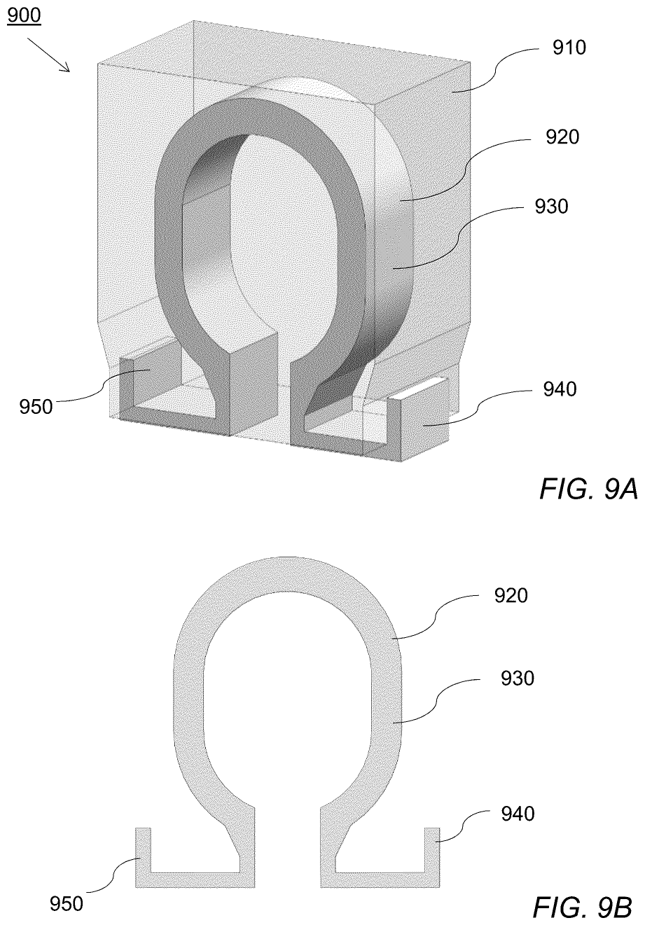

FIGS. 2A-2C show a conductive coil 200 according to an exemplary embodiment described herein. The conductive coil 200 is preferably a preformed member formed from a conductive material, such as a metal plate, sheet or strip. Acceptable metals used for forming the conductive coil 200 may be copper, aluminum, platinum, or other metals for use as inductor coils as are known in the art. In an exemplary embodiment the conductive coil may be made into a preformed member by bending the conductive material into a selected shape. Non-limiting examples of wires that can be used to form the conductive coil 200 include a flat wire, square wire, or rectangular shaped wire, round wire. One of skill in the art will recognize that other wire shapes could be used within the scope of this invention. The conductive coil 200 can have a uniform thickness, for example, such as that depicted in FIGS. 2A-2C, or can have varying thicknesses, for example, as shown in FIGS. 8A-8C and 9A-9B. In an embodiment, the conductive coil 200 can be a unitary, one-piece member. In another embodiment, the conductive coil 200 can consist of multiple pieces joined together, such as by welding, provided that the conductive coil 200 is fully formed prior to forming the inductor body about the conductive coil in a molding process.

The conductive coil 200 is preferably shaped in a configuration that provides for increased efficiency and performance in a small volume and that is simple to manufacture and results in minimal to no waste product. The shape of the conductive coil 200 is designed to optimize the path length to fit the space available within the inductor body 110 while minimizing resistance and maximizing inductance.

As shown in the exemplary embodiment FIGS. 2A-2C, the conductive coil 200 preferably has right and left ends forming right and left leads 210, 220 and a medial portion 230. The right and left leads 210, 220 are preferably formed into an L-shape or a U-shape. One of skill in the art will recognize that when the right and left leads 210, 220 are formed into an L-shape or a U-shape, such L-shape or U-shape can consist of substantially right angle sections, for example, as shown in FIGS. 2A-2C, or substantially rounded sections, for example, as shown in FIGS. 8A-8C (discussed herein). The medial portion 230 is preferably formed in a circular or semi-circular shape; however, other shapes could be used based on the required inductor properties. In an embodiment, the medial portion 230 is preferably a single semi-circular shape, for example, as shown in FIGS. 2A-2C, or an oblong shape, for example, as shown in FIGS. 9A-9B, discussed herein. In addition, the medial portion 230 can include one or more wound circular segments or stacked coils. As shown in the preferred embodiment of FIGS. 2A-2C, the conductive coil 200 can be a flat wire that is omega-shaped having L-shaped right and left leads 210, 220 and a semi-circular medial portion 230. One of skill in the art will recognize that the right and left leads 210, 220 and medial portion 230 can be formed in other shapes suitable for performing the desired inductive properties within the scope of the present invention.

As shown in the exemplary embodiment of FIGS. 2A-2C, the conductive coil 200 has a bottom side 240 where the right and left leads 210, 220 are formed, a top side 250, a right side 260, a left side 270, a front side 280, and a back side 290. In an embodiment, the back side 290 is preferably a mirror image of the front side 280, and the left side 270 is preferably a mirror image of the right side 260. In an exemplary embodiment, the medial portion 230 has right and left extension legs 232, 234 adjacent the right and left leads 210, 220, respectively. Each of the right and left leads 210, 220 preferably comprises a bottom portion 212, 222 and side portion 214, 224. The bottom portion 212, 222 of each lead 210, 220 is preferably positioned between a respective one of the right and left extension legs 232, 234 and side portions 212, 222. The side portions 214, 224 preferably form the terminal end of each lead 210, 220. The side portions 214, 224 are preformed to be substantially perpendicular to the bottom portions 212, 222 of each lead 210, 220. While leads 210, 220 are illustrated with side portions 214, 224, one of skill in the art will recognize that the side portions 214, 224 can be omitted, and leads 210, 220 can terminate at the bottom portions 212, 222.

Referring back to FIGS. 1A-1H, each lead 210, 220 has a termination that is preferably exposed outside of the inductor body 110 and preformed such that at least a portion of the bottom portion 212, 222 of each lead 210, 220 is exposed along the lead side 120 of the inductor body 110 and the side portion 214, 224 of each lead 210, 220 is exposed along the respective right and left side 140, 150 of the inductor body 110. In an embodiment, the leads 210, 220 are L-shaped and are positioned along the lead side 120 and left and right sides 140, 150 of the inductor body 110. As used herein, “L-shape” or “L-shaped” includes two leg segments joined at an angle or by a curved member. For example, the bottom portion 212, 222 can extend to the side portion 214, 224 of each lead 210, 220 through a curved segment or a sharp angle.

As best shown in FIGS. 1E and 1F, an indentation or cutout 142, 152 can be formed in each of the right and left sides 140, 150 of the inductor body 110. The inductor body 110 has a smaller width W₃ at the cutouts 142, 152 as compared to a maximum width W₂ of the inductor body 110. The exposed side portion 214, 224 of each lead 210, 220 is positioned along a respective cutout 142, 152 to minimize the impact of the leads 210, 220 in the width direction. In particular, by positioning the exposed side portion 214, 224 of each lead 210, 220 along a respective cutout 142, 152, the maximum width W₁ of the conductive coil 200 between the leads 210, 220 can be substantially the same width as the maximum width W₂ of the inductor body 110. Thus, the exposed side portion 214, 224 of each lead 210, 220 are substantially in line with a respective right and left side 140, 150 of the inductor body 110, which allows the overall size of the inductor 100 to be minimized. It is appreciated that the cutouts 142, 152 are not required in all circumstances, and the side portions 214, 224 of the leads 210, 220 could be formed along the right and lefts sides 140, 150 of the inductor body 110 without the cutouts 142, 152.

FIGS. 1B, 1D, 1F, and 1H show an exemplary embodiment of the inductor body 110 in partial transparency so as to view the conductive coil 200 within the interior of the inductor body 110. The finished inductor 100 according to the present invention preferably includes the inductor body 110 molded, formed about, pressed over, etc, the conductive coil 200. At least parts of the leads 210, 220 are exposed outside of the inductor body 110 at the lead side 120 and lower portions of the right and left sides 140, 150 of the inductor body 110. The leads 210, 220 form a significant portion of the bottom side or lead side 120 of the inductor 100.

The length, width, and height of the conductive coil 200 and inductor body 110 may vary based on the inductor application. The dimensions of the conductive coil 200 may be designed to increase the ratio of the space used compared to the space available in the inductor body 110.

As shown in FIG. 1F, in an embodiment, the conductive coil 200 may have a vertical height H₁ (from the bottom side 240 to the top side 250) that is substantially equal to or smaller than the vertical height H₂ of the inductor body 110 (from the lead side 120 to the top side 130). Because at least a portion of the leads 210, 220 of the conductive coil 200 are outside of the inductor body 110 in the formed inductor 100, at least the medial portion 230 of the conductive coil 200 can be completely embedded within the inductor body 110 when the conductive coil 200 and inductor body have substantially the same vertical height. Alternatively, the conductive coil 200 may have a vertical height H₁ that is >99%, >98%, >95%, >90%, >85%, >75%, >60%, or >50% of the vertical height H₂ of the inductor body 110.

Also as shown in FIG. 1E, the maximum width W₁ of the conductive coil 200 is substantially equal to the maximum width W₂ of the inductor body 110. One of ordinary skill in the art will recognize that the maximum width W₁ of the conductive coil 200 or the maximum width W₂ of the inductor body could be slightly different without departing from the spirit of the invention.

As shown in FIG. 1H, the depth D₁ of the conductive coil 200 is preferably less than the depth D₂ of the inductor body 110. For example, the conductive coil 200 may be centered within the inductive body 110 along the depth direction and have a depth D₁ that is approximately 50% of the depth D₂ of the inductor body 110. One of ordinary skill in the art will recognize that the maximum width W₁ of the conductive coil 200 or the depth D₁ of the inductor body could be greater or less than 50% of the depth D₂ of the inductor body 110 without departing from the spirit of the invention.

In a non-limiting example, the maximum dimensions of the finished inductor can be approximately 10 mm (vertical height (H₃))×10 mm (width (W₂))×6 mm (depth (D₂). In such an embodiment, the vertical height H₁ of the conductive coil 200 is approximately 9 mm and the maximum vertical height H₃ of the inductor 100 is approximately 10 mm. The maximum width W₁ of the conductive coil 200 and maximum width W₂ of the inductor body 110 are both approximately 10 mm. The depth D₁ of the conductive coil 200 is approximately 3 mm and the depth D₂ of the inductor body 110 is approximately 6 mm. In a preferred embodiment, the inductor may achieve resistance below 0.15 mΩ and inductance above 100 nH while achieving a current rating which causes a 40° C. or less temperature rise above 100A. In an embodiment, the current handling capability can be in the range of 100-125A creating a 40° C. or less temperature rise.

One of skill in the art will recognize that there can be many variations in the length, width, and height of the conductive coil 200 and inductor body 110 within the scope of this disclosure. Other non-limiting examples of inductor dimensions according to the present disclosure include: 10 mm (H₃)×10 mm (W₂)×5 mm (D₂); 12 mm (H₃)×10 mm (W₂)×5 mm (D₂); 7 mm (H₃)×10 mm (W₂)×5 mm (D₂); and 5 mm (H₃)×8 mm (W₂)×4 mm (D₂).

In an embodiment, the resistance can range from 0.01 mΩ to 5.0 mΩ and the inductance can range from 10 nH to 1000 nH. One of skill in the art will recognize that the resistance typically increases as the inductance increases. However, the inductance can increase without an increase in resistance as the size of the inductor body 110 increases.

FIGS. 8A-8C illustrate an inductor 800 according to alternative embodiment described herein. Inductor 800 is generally formed of the same materials as inductor 100 shown in FIGS. 1A-1H. As shown in FIG. 8A, inductor 800 preferably includes an inductor body 810 partially surrounding a preformed conductive coil 820. Inductor 800 differs from inductor 100 shown in FIGS. 1A-1H and conductive coil 200 shown in FIGS. 2A-2C in that inductor 800 has a conductive coil 820 with a medial section 830 having different dimensions as compared with the right and left ends forming the right and left leads 840, 850. As shown in the preferred embodiment of FIGS. 8A and 8B, the conductive coil 820 is preferably a flat wire with an omega-shaped having L-shaped right and left leads 840, 850 and a semi-circular medial portion 830. The medial portion 830 of the conductive coil 820 preferably has a greater thickness than right and left leads 840, 850. The thickness of the wire gradually tapers from medial portion 830 along right and left extension legs 860 and 870. As a result, right and left leads 840, 850 preferably have a cross-sectional area that is flatter and wider than a cross-sectional area of the medial portion 830 as shown in FIG. 8C.

The inductor 800 depicted in FIGS. 8A-8C is advantageous in that the flatter, wider leads 840, 850 allow for greater stability particularly when making larger sized inductors. It also allows for an inductor to be made with a wider inductor body in the depth direction (direction (D) referenced in FIG. 1H), which results in additional core material and increased inductance.

In addition, increasing the width of the inductor's lead termination, such as inductor 800, allows for a thinner lead termination with the same cross sectional area. As a result, the electrical resistance of the lead termination can remain substantially the same while freeing additional space for core material in the same effective area. Because the size of the inductor is typically determined by the amount of space that it will take up on a circuit board, an inductor, such as inductor 800, in accordance with the present embodiment can more efficiently use the available circuit board space. In addition, an inductor having a wider lead termination, such as inductor 800, allows for a larger lead surface area to mount to a circuit board, which can provide a more secure attachment to a circuit board.

A wider lead termination, such as in inductor 800, also improves the inductor's shock and vibration handling capabilities, and improves heat transfer between the inductor and a circuit board. In addition, thinner, wider lead terminations, such as in inductor 800, are easier to form or bend.

In addition, one of skill in the art will recognize that an inductor having the reverse configuration, made with a flatter, wider medial portion and thicker narrower leads, is within the spirit and scope of the subject matter of the present application. An inductor made with a flatter, wider medial portion and a narrower lead can be used to match an existing circuit board footprint. For example, this advantageous in circuit boards having a fixed design or layout to fit a specific size inductor.

FIG. 9A-9B show an inductor 900 according to another alternative embodiment described herein. Inductor 900 is generally formed of the same materials as inductor 100 shown in FIGS. 1A-1H and inductor 800 shown in FIGS. 8A-8C. As shown in FIG. 9A, inductor 900 preferably includes an inductor body 910 partially surrounding a preformed conductive coil 920. Inductor 900 preferably has a conductive coil 920 preferably formed of a flat wire with an omega-shaped having a medial section 930 and L-shaped right and left leads 940, 950. Similar to inductor 800 shown in FIGS. 8A-8C, the medial portion 930 of the conductive coil 920 preferably has a greater thickness than right and left leads 940, 950, and the thickness of the wire gradually tapers from medial portion 930 towards the right and left leads 940, 950 such that the right and left leads 940, 950 are preferably flatter than medial portion 930 as shown in FIGS. 9A-9B. Inductor 900 differs from inductor 800 shown in FIGS. 8A-8C in that the medial portion 930 of the conductive coil 920 is oblong shaped as opposed to being semi-circular shaped, and the inductor body 910 has a greater height than its width. For example, and without limitation, the height to width ratio can be approximately 1.5:1 or 2:1. Alternatively, according to another embodiment (not shown), the medial portion of the conductive coil can be oblong shaped such that it has a smaller height relative to its width.

The inductor 900 depicted in FIGS. 9A-9B is advantageous in that the inductor body 910 can have various heights and widths to allow for a broader spectrum of applications. An inductor, such as inductor 900, is advantageous to customize the size of the inductor to more efficiently utilize the available space on a circuit board. For example, this is useful in applications where the circuit board's footprint is limited, but the height is more flexible. Similarly, this is also useful in applications in which the inductor's height is a limiting factor, but there is greater flexibility with the inductor's width or length.

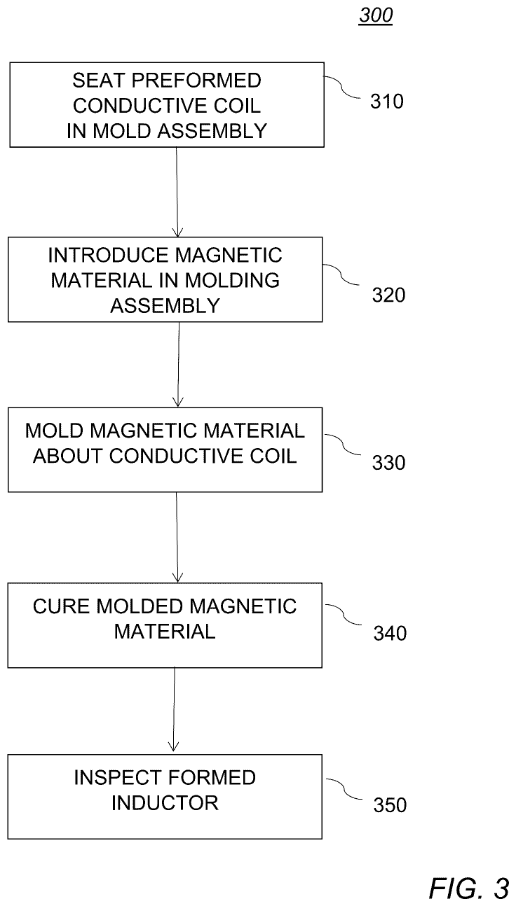

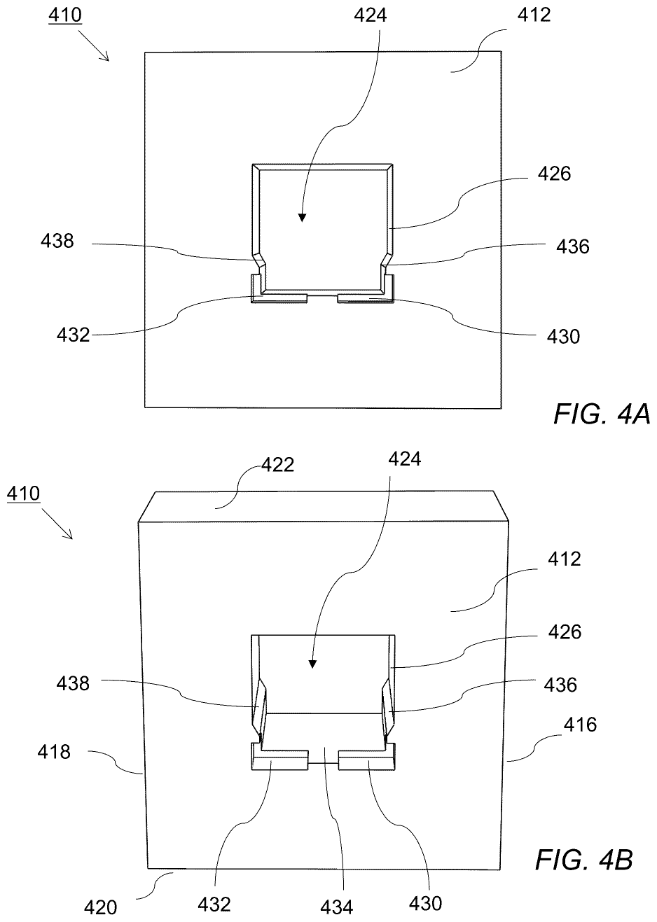

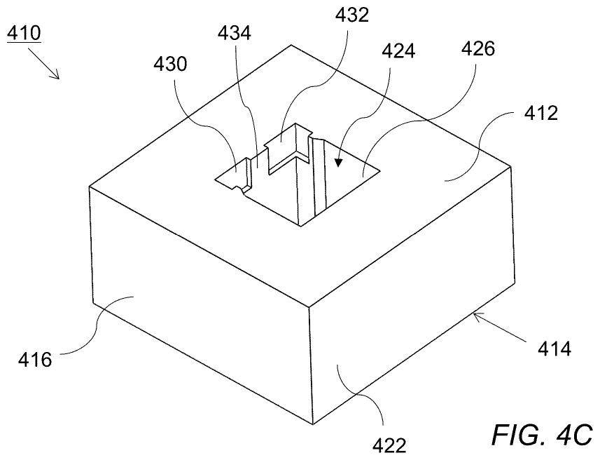

FIG. 3 depicts an exemplary method 300 for making an inductor according to the present invention. In an embodiment, inductor body 110 may be formed from pressing a magnetic material around the preformed conductive coil 200. One of skill in the art will understand that the method of making an inductor described in FIG. 3 and the mold assembly described in FIGS. 4-7 reference inductor 100 for exemplary purposes only. One of skill in the art will understand that inductors using preformed conductive coils having different sizes and shapes and inductor bodies of different sizes and shapes are within the scope and spirit of the method and mold assembly described in FIGS. 3-7.

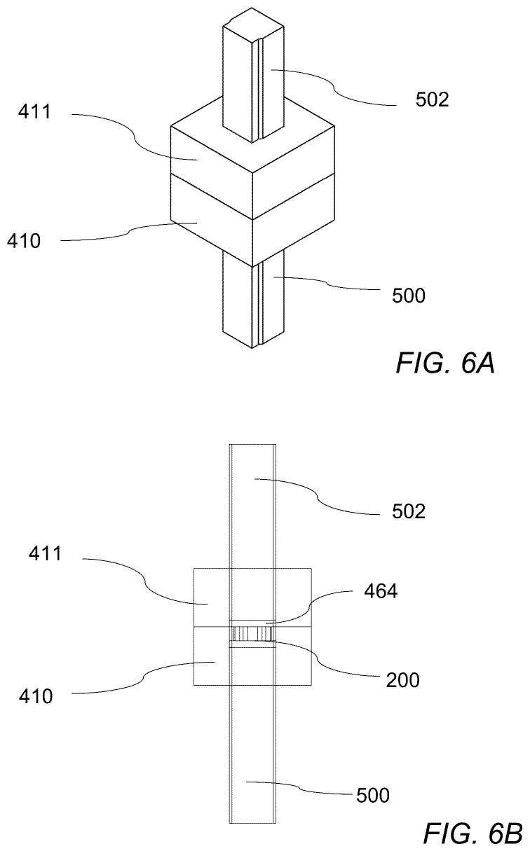

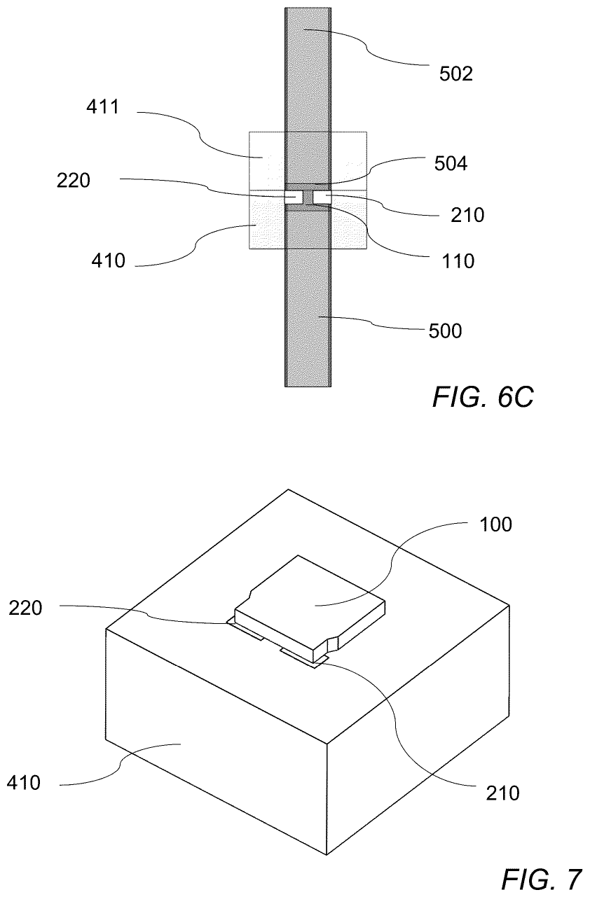

At step 310 the preformed conductive coil 200, such as that depicted in FIGS. 2A-2C, is preferably seated in a mold assembly 400. An exemplary mold assembly 400 is depicted in FIGS. 6A-6C with an upper mold section 410 and a lower mold section 411. One of skill in the art will recognize that terms “lower” and “upper” are used as points of reference in the drawings, and that lower mold section 410 can be at a top side of the mold assembly 400 and upper mold section 411 can be at a bottom side of the mold assembly 400. One of skill in the art will also understand that a single mold section or multiple mold sections can be used within the scope of the present invention.

As shown in FIGS. 4A-4C, the lower mold section 410 is preferably block shaped having a top side 412, a bottom side 414, a right side 416, a left side 418, a front side 420, and a back side 422. One of skill in the art will recognize that the lower mold section 410 can have other shapes without departing the scope of the invention. The lower mold section 410 preferably has one or more seating channels 424. In the exemplary embodiment depicted in FIGS. 4A-4C, the lower mold section 410 has one seating channel 424; however, one of skill in the art will recognize that the lower mold section 410 can have multiple seating channels for production efficiency within the scope of the present invention. The seating channel 424 preferably extends from the top side 412 to the bottom side 414 through the lower mold section 410, and is preferably open on both the top side 412 and the bottom side 414. However, in an embodiment, the seating channel 424 can be closed one side. The lower mold section 410 can include an alignment hole (not shown) to align the lower mold section 410 with the upper mold section 411 during the molding process.

As shown in FIGS. 4A-4C, the seating channel 424 is defined by a channel wall 426. A right shelf 430 and left shelf 432 are preferably formed in the channel wall 426 and positioned to receive the right and left leads 210, 220 of the conductive coil 200. The right shelf 430 and left shelf 432 preferably have a shape that is complementary to the shape of leads 210, 220. In an embodiment, the right shelf 430 and left shelf 432 are L-shaped to accommodate the L-shaped leads 210, 220 of the conductive coil 200. An intermediate protrusion 434 is formed in the channel wall 426 and preferably positioned between the right and left shelves 430, 432. The intermediate protrusion 434 acts to form the section of the lead side 120 of the inductor body 110 positioned between the leads 210 and 220 in the formed inductor (see FIG. 1A). The seating channel 424 preferably has right and left narrowing walls 436, 438 formed in the channel wall 426 that form the right and left cutouts 142, 152 in the inductor body 110.

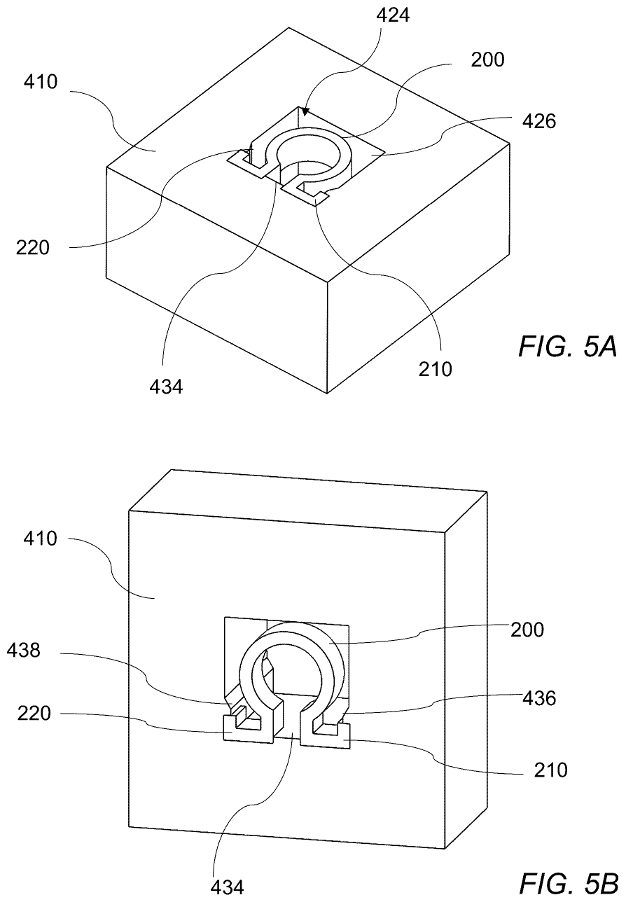

As shown in FIGS. 5A and 5B, the conductive coil 200 is preferably positioned in the seating channel 424 such that the right and left leads 210, 220 are seated within the right and left shelves 430, 432 of seating channel 424 and contact the channel wall 426. The right and left shelves 430, 432, right and left narrowing walls 436, 438, intermediate protrusion 434, and channel wall 426 preferably act together to limit movement of the conductive coil 200 during molding. In addition, the intermediate protrusion 434 and right and left leads 210, 220 preferably function to form the lead side 120 of the inductor body 110.

FIGS. 6A-6C illustrate an exemplary embodiment of the mold assembly 400 including lower mold section 410, upper mold section 411, a lower punch 500, and an upper punch 502. In an embodiment, the upper mold section 411 is preferably block shaped. One of skill in the art will recognize that the upper mold section 411 can have other shapes without departing the scope of the invention. The upper mold section 411 preferably has a receiving channel 464. One of skill in the art will recognize that the upper mold section 411 can have multiple receiving channels 464 to correspond with the number of seating channels 424 in the lower mold section 410. The receiving channel 464 preferably extends from a top side to a bottom side of the upper mold section 411, and is preferably open on both the top side and the bottom side. The upper mold section 411 can include an alignment hole (not shown) to align with the lower mold section 410 during the molding process.

Referring back to FIG. 3, at step 320, a magnetic material 504 can be introduced into the molding assembly 400. The magnetic material 504 is preferably magnetic particles, more preferably a powdered or granular magnetic material, and even more preferably a powdered iron material. The magnetic material 504 is preferably poured into the mold assembly 400 about the conductive coil 200. In an embodiment, a portion of the magnetic material 504 can be pre-compacted or pre-pressed and added to the mold assembly 400 along with the conductive coil 200. The pre-compacted or pre-pressed magnetic material can be subjected to an initial pressing step, and additional loose magnetic material 504 can then be added to the mold assembly 400 during a final pressing step.

At step 330, the magnetic material 504 is molded about the conductive coil 200 within the mold assembly 400. The magnetic material 504 is preferably pressed by lower and upper punches 500, 502 into an inductor body 110 that encompasses the conductive coil 200, with the exception of the exposed portions of the right and left leads 210, 220. In the exemplary embodiment shown in FIGS. 6A-6C, the lower punch 500 is inserted through the seating channel 424 from the bottom side 414 of the lower mold section 410, and upper punch 502 is inserted through the receiving channel 464 from the top side of the upper mold section 411 to press the powdered magnetic material about the conductive coil 200. FIG. 6B illustrates the mold assembly 400 without a magnetic material inserted about the conductive coil 200. FIG. 6C illustrates the mold assembly 400 with a magnetic material 504 inserted and pressed about the conductive coil 200. One of ordinary skill in the art will recognize that other forms of molding a powdered magnetic material can be employed without departing from the scope of the described method 300, including, without limitation, pressure molding, injection molding, etc.

FIG. 7 illustrates a formed inductor 100 seated within lower mold section 411 after the molding step. After the molding the step, the magnetic material 504 is formed into a composite material about the conductive coil 200.

Referring back to FIG. 3, after the inductor 100 is formed by the molding process of step 330, the formed inductor 100 is cured, such as by heating in an oven, at step 340. This curing process binds the powdered magnetic materials forming the inductor body together. One of skill in the art will recognize that other forms of curing can be utilized without departing from the scope of the present invention.

At step 350, the formed inductor 100 is optionally inspected, such as by visual inspection and/or electrical characteristic inspection. The unique arrangement of the leads 210, 220 allows for a stronger solder joint connection between the inductor and a circuit board, and also allows for improved visibility during overhead inspection, such as AOI or x-ray inspection.

An inductor 100 made with the preformed conductive coil 200 according to any of the embodiments discussed herein eliminates the need for welding the leads to a lead frame, a resulting weld joint, and post-process cutting of the lead frame, which improves inductor performance. An inductor 100 made with the preformed conductive coil 200 according to any of the embodiments discussed herein also eliminates the need for post-press lead processing, such as forming and/or bending the leads about the inductor body.

As discussed above, the leads 210, 220 of the conductive coil 200 function as a significant part of the seating channel 424, 426 wall during molding. This allows for an inductor 100 having the smallest footprint available while maximizing the useable core area within the inductor body 110. In addition, the arrangement of the conductive coil 200 within the seating channel 466 of the mold assembly 200 of the present invention limits movement of the conductive coil 200 during molding, which allows for consistent positioning of the conductive coil 200 within the inductor body 110, and preferably, within the center of the inductor body 110.

As shown in FIGS. 1A, 1B, 1G, and 1H, the exposed portions of the right and left leads 210, 220 make up a significant portion of the lead side 120 of the inductor body 110 which maximizes solder joint strength, and makes the inductor ideal for surface mount applications. In addition, the side portions 214, 224 provide additional shock and vibration stability to the finished inductor 100.

An inductor according to any of the embodiments discussed herein may be utilized in electronics applications, with relatively small footprint, surface mount, and/or high profile requirements, such as server applications or other applications including DC/DC converters for servers, ultrabooks, notebooks, automotive BLDC motors, and solar inverters. In addition, an inductor according to any of the embodiments discussed herein can preferably achieve one or more of the following: low direct current resistance (DCR) below 0.15 mΩ; inductance above 100 nH; direct current handling capability in the range of 100-125A while creating a 40° C. temperature rise or less, a low profile and high current; efficiency in circuits and/or in situations where similar products cannot meet electric current requirements.

The formed inductor 100 described herein, provides a simple and cost-effective way to produce consistent inductors with minimal waste materials. Nearly all of the material used to make the inductor 100 are utilized in the finished product. Significant part and labor costs are achieved by the inductor 100 described herein as compared to competitive products which have waste parts, such as lead frames and wires, and additional labor requirements, due to post-processing trimming and forming.

It will be appreciated that the foregoing is presented by way of illustration only and not by way of any limitation. It is contemplated that various alternatives and modifications may be made to the described embodiments without departing from the spirit and scope of the invention. Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A method for making an inductor, comprising:
providing a formed conductive coil having a curve-shaped medial portion and first and second terminal leads; and
molding a magnetic material around at least the medial portion of the formed conductive coil to form an inductor body, wherein at least a portion of each of the first and second terminal leads of the formed conductive coil is exposed outside of the inductor body.

2. The method of claim 1, wherein the formed inductor body is substantially package shaped having a bottom side, a top side, a right side, a left side, a front side, and a back side, and the portion of each of the first and second terminal leads exposed outside of the inductor body comprises a bottom portion exposed along the bottom side of the inductor body.

3. The method of claim 2, wherein molding the magnetic material further comprises:
positioning the formed conductive coil in a mold assembly;
introducing the magnetic material into the mold assembly; and
pressing the magnetic material around the conductive coil.

4. The method of claim 2, wherein the formed inductor body is substantially package shaped having a bottom side, a top side, a right side, a left side, a front side, and a back side, and the portion of the first terminal lead exposed outside of the inductor body is further comprises a side portion exposed along the right side of the inductor body and the portion of the second terminal lead exposed outside of the inductor body is further exposed along the left side of the inductor body.

5. The method of claim 4, wherein molding the magnetic material further comprises:
positioning the formed conductive coil in a mold assembly;
introducing the magnetic material into the mold assembly; and
pressing the magnetic material around the conductive coil.

6. The method of claim 5, wherein positioning the formed conductive coil in the mold assembly further comprises:
seating the first and second terminal leads of the formed conductive coil on first and second shelves formed within a wall of a seating channel of the mold assembly,
wherein the first and second shelves having a shape that is complementary to the first and second terminal leads such that the first and second terminal leads function as a part of the wall of the mold assembly during molding.

7. The method of claim 6, wherein the first and second terminal leads are L-shaped or U-shaped.

8. The method of claim 7, wherein the first and second shelves each further comprise a narrowing wall which forms a complementary cutout in each of the right side and the left side of the inductor body, and
a portion of each of the first and second terminal leads is positioned in a respective cutout.

9. The method of claim 4, wherein the side portion of each of the first and second terminal leads is substantially perpendicular to the bottom portion of each of the first and second terminal leads.

10. The method of claim 1, wherein the magnetic material is further molded around portions of the first and second terminal leads of the conductive coil.

11. The method of claim 1, wherein the conductive coil is omega-shaped.

12. The method of claim 1, wherein the formed inductor body is substantially package shaped having a bottom side, a top side, a right side, a left side, a front side, and a back side, and
a height of the formed inductor body extends between the top side and the bottom side and a depth of the formed inductor body extends between the front side and the back side, the height of the formed inductor body being greater than the depth of the formed inductor body.

13. A method for making an inductor, comprising:
providing a formed conductive coil having a medial portion comprising a single curve-shaped turn positioned between first and second extension legs extending from first and second symmetrical terminal leads, the formed conductive coil having a top side and bottom side in a height direction and a first side and a second side in a width direction, the first and second extension legs extend in the height direction from the bottom side of the formed conductive coil, the single curve-shaped turn extends from the first and second extension legs towards the top side of the formed conductive coil, the single curve-shaped turn has a first portion that curves outwardly from the first extension leg toward the first side and a second portion that curves outwardly from the second extension leg toward the second side; and
molding a magnetic material around at least the medial portion of the formed conductive coil to form a unitary inductor body, wherein at least a portion of the first and second symmetrical terminal leads of the formed conductive coil are exposed outside of the unitary inductor body;
wherein the unitary inductor body is substantially package shaped having a bottom side, a top side, a right side, a left side, a front side, and a back side, a height of the unitary inductor body extends between the top side and the bottom side and a depth of the unitary inductor body extends between the front surface and the back surface, the height of the unitary inductor body being greater than the depth of the unitary inductor body, and
the first and second terminal leads are exposed along the bottom side of the unitary inductor body.

14. The method of claim 13, wherein the first and second symmetrical terminal leads are also exposed along a respective one of the first side surface and the second side surface of the unitary inductor body.

15. The method of claim 14, wherein molding the magnetic material further comprises:
positioning the formed conductive coil in a mold assembly;
introducing the magnetic material into the mold assembly; and
pressing the magnetic material around the formed conductive coil.

16. The method of claim 13, wherein the first and second extension legs extend in a height direction from the bottom side of the unitary inductor body, the single curve-shaped turn extends from the first and second extension legs towards the top side of the unitary inductor body, the single curve-shaped turn has a first portion that curves outwardly from the first extension leg toward the first side surface and a second portion that curves outwardly from the second extension leg toward the second side surface.

17. The method of claim 13, wherein the magnetic material is molded around the medial portion and portions of the first and second symmetrical terminal leads of the conductive coil.

18. The method of claim 13, wherein the conductive coil is omega-shaped.

19. A method for forming an inductor having a preformed conductive coil comprising a medial portion between first and second terminal leads, the method comprising:
providing a mold section having a seating channel defined there through and a wall surrounding the seating channel, the wall comprising first and second shelves, the first and second shelves have a shape that is complementary to the respective first and second terminal leads of the preformed conductive coil;
positioning the preformed conductive coil in the mold section such that the first and second shelves receive the respective first and second terminal leads of the preformed conductive coil and the first and second terminal leads contact the wall of the mold section;
pressing magnetic particles around the conductive coil positioned within the mold section to form the inductor; and
removing the formed inductor from the mold section.

20. The method of claim 19, wherein the preformed conductive coil is omega-shaped.
